(19) United States
(12) Patent Application Publication
(10) Pub. No.: US 2022/0287490 A1
(43) Pub. Date: Sep. 15, 2022

(54) Magnetic Holder for Beverages

(71) Applicant: James Singleton, Pasadena, MD (US)

(72) Inventor: James Singleton, Pasadena, MD (US)

(21) Appl. No.: 17/686,634

(22) Filed: Mar. 4, 2022

Related U.S. Application Data
(60) Provisional application No. 63/160,241, filed on Mar. 12, 2021.

(51) Int. Cl. A47G 23/02; B60N 3/10

(52) U.S. Cl. CPC A47G 23/0216; B60N 3/10

(57) ABSTRACT

The present invention relates to a magnetic cup and beverage holder device. The holder device includes two magnets of opposing polarities, which allow an enclosed cup and/or beverage to remain stable and erect without spilling, even in a moving vehicle. The magnets are positioned within the base of the holder device, thereby creating a strong magnetic attractive force which stabilizes the enclosed cup and/or beverage. The holder device can either be used as an insert in a cup holder, or as a standalone device. The holder device prevents spilling and excess shaking of the beverage and eliminates loss of carbonation.

### CROSS-REFERENCE TO RELATED APPLICATION

The present application claims priority to, and the benefit of, U.S. Provisional Application No. 63/160,241, which was filed on Mar. 12, 2021 and is incorporated herein by reference in its entirety.

### FIELD OF THE INVENTION

The present invention relates generally to the field of beverage holders. More specifically, the present invention relates to a beverage holding device that utilizes opposing magnets to ensure the beverage holding device remains stable while travelling in a moving vehicle such as a car, boat, etc. The magnetic beverage holding device comprises a larger holder with a magnetic base and a slightly smaller holder with an opposite magnetic base, wherein the smaller holder is mounted inside the larger holder. The base of the larger holder and the smaller holder are attracted due to the magnetic force of attraction acting between the opposing magnets. Further, the smaller holder is used for retaining beverages. The magnetic beverage holding device maintains a beverage in a stable, upright position to prevent spills, even while in a moving vehicle such as an ATV, boat, lawnmower, car, etc., and also ensures that carbonated drinks do not go flat due to the constant shaking and vibration of a vehicle. Accordingly, this disclosure makes specific reference thereto the present invention. Nonetheless, it is to be appreciated that aspects of the present invention are also equally applicable to other like applications, devices and methods of manufacture.

### BACKGROUND OF THE INVENTION

By way of background, various kinds of beverage holding devices are available from which a beverage can be consumed. For example, devices such as cups, mugs, drinking cups and other types of drinking vessels are used for consuming different kinds of beverages. Also, beverage holding devices are often used for serving beverages at restaurants and other similar places.

Generally, the beverage holding devices are configured in various shapes, sizes, and designs, however a standard cylindrical-shaped structure with a top opening for accessing a beverage from within is quite common. The top opening of conventional cups allows the beverage inside to be easily spilled, even with the slightest jerk.

Additionally, users may enjoy drinking different beverages while on a boat, traveling in a car, riding a lawnmower, etc. It can be difficult to keep the beverage stable in conventional beverage holding devices such as cups, mugs, etc., while travelling via boat, car, riding a lawnmower, etc. Even if a user retains the beverage holding device in his or her hand, it can be quite difficult to stabilize the beverage held within the device while performing other tasks.

Further, vehicles such as cars, boats, etc., are equipped with cup holders for retaining beverage containers, e.g., cups, mugs, beverage cans, etc., which can be held in place while the vehicle is in motion or at a stop. Generally, the structure of a cup holder includes a hole or cavity in which a beverage container can be inserted. However, when a beverage is placed into the cup holder inside the vehicle, it can result in spillage of the beverage when the vehicle is in motion or is subjected to unpaved or poorly surfaced roads. Once the beverage spills over the sides, it can be extremely difficult to clean up the mess inside the vehicle, and may require a professional vehicle cleaning.

Additionally, consuming beverages such as carbonated beverages while riding in a moving vehicle, could not only cause the carbonated beverage to spill, but could also cause the beverage to go flat due to the constant shaking and vibration of the vehicle. Thus, existing beverage holders do not provide a convenient means for handling beverages in a cup holder while travelling in a car, boat, riding a lawnmower, etc.

Therefore, there exists a long felt need in the art for a beverage holding device that can be used for holding and consuming beverages. There exists a long felt need in the art for a beverage holding device that allows users to serve beverages or consume beverages without worry of spills, even while in or on a moving vehicle such as a car, boat, lawnmower, etc. There is a long felt need in the art for a beverage holding device that ensures that the beverage held inside the device stays in a stable upright position to prevent spills while riding on moving vehicles. There is a long felt need in the art for a beverage holding device that allows users to easily consume beverages while performing other tasks, without the beverage spilling. Additionally, there is a long felt need in the art for a beverage holding device which can be used with existing vehicle cup holders, to ensure that the beverage/drink remains stable even when the vehicle is in motion or is subjected to unpaved or poorly surfaced roads. Furthermore, there is a long felt need in the art for a beverage holding device that prevents carbonated beverages from going flat due to the constant shaking and vibration of a vehicle. Finally, there is a long felt need in the art for a beverage holding device that allows users to easily handle different beverages while travelling in a vehicle, boat, etc., without worry of spills or getting their hands dirty.

The subject matter disclosed and claimed herein, in one embodiment thereof, comprises a magnetic holder device for beverages. More specifically, the magnetic holder device comprises an inner holder and a larger, outer holder, wherein the inner holder is configured to be encompassed within the larger, outer holder. Further, the inner holder comprises a first magnet of a first magnetic polarity in a first bottom cavity, and the larger, outer holder comprises a second magnet also of the first magnetic polarity in a second bottom cavity. The first magnetic polarity is the same in both holders, thus creating a repelling magnetic force between the first magnet and the second magnet and thus allowing the first bottom cavity to float above the surface of the second bottom cavity and allowing a beverage stored in the inner holder to be stable, erect, and immune to any forces of the outer holder. Both the inner holder and the larger, outer holder are cylindrical in shape, thereby allowing a cup to be accommodated within the inner holder.

In this manner, the novel magnetic holder device of the present invention accomplishes all of the forgoing objectives, and provides a relatively safe, easy and cost-effective solution to maintaining a beverage in a stable, upright position to prevent spills, even while in a moving vehicle. The device allows users to enjoy their favorite beverages without worry of spills or loss of carbonation.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a magnetic holder device for beverages. The magnetic holder device comprises an inner holder and a larger, outer holder, wherein the inner holder is configured to be encompassed within the larger, outer holder. Further, the inner holder comprises a first magnet of a first magnetic polarity in a first bottom cavity, and the larger, outer holder comprises a second magnet of also of the first magnetic polarity in a second bottom cavity. The first magnetic polarity is the same polarity as the second magnet, creating a repelling force between the first magnet and the second magnet, and allowing the first bottom cavity to float above the second bottom cavity, thus allowing a beverage stored in the inner holder to be stable and erect. Both the inner holder and the larger, outer holder are cylindrical in shape allowing a cup to be accommodated within the inner holder.

In yet another embodiment of the present invention, the first magnet and the second magnet can be a Nickel magnet, Nickel Iron magnet, Neodymium magnet or any other suitable temporary magnet. The strength of the first magnet and the second magnet can be similar, or the first magnet can have a larger magnetic force than the second magnet, or the reverse. The inner holder is removable from the larger, outer holder, and the magnets are built into the bottom of the inner holder and the larger, outer holder.

In yet another embodiment of the present invention, a magnetic hovering holder device for a cup is disclosed. The magnetic hovering holder device includes a cylindrical body having a connected base, wherein the circumference of the base is smaller than the circumference of the cross-sectional circular area of the cylindrical body. Further, the cross-sectional circular periphery of the cylindrical body comprises a first magnet having a first magnetic polarity, and the base comprises a second magnet also of the first magnetic polarity, wherein the first magnetic polarity is the same as the second magnetic polarity, thus allowing a cup inserted into the hovering holder device to remain stable and hover due to the repelling magnetic force between the first magnet and the second magnet.

In a further embodiment of the present invention, the magnetic holder device or the magnetic hovering holder device can be used as a cupholder insert or as a standalone device. The holder device maintains a beverage in a stable, upright position to prevent spills, even while in or on a moving vehicle like an ATV, boat, lawnmower, car, etc.

In yet another embodiment of the present invention, a magnetic cup holder insert is disclosed. The insert includes two magnets of the same magnetic polarities, wherein the magnetic repelling force between said two magnets supports the beverage and maintains the beverage in a stable, upright position to prevent spills.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the magnetic holder device of the present invention for holding cups and beverages in accordance with the disclosed architecture;

FIG. 2 illustrates a perspective view of one potential embodiment of the magnetic holder device of the present invention in use as a cupholder insert in a cupholder of a vehicle in accordance with the disclosed architecture;

FIG. 3 illustrates a perspective view of one potential embodiment of the magnetic holder device of the present invention having magnetic bases in accordance with the disclosed architecture;

FIG. 4 illustrates a perspective view of another potential embodiment of the magnetic holder device of the present invention for holding a cup in accordance with the disclosed architecture; and

FIG. 5 illustrates a perspective view of one potential embodiment of the magnetic holder device of the present invention as a cupholder insert in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a beverage holding device or utensil that can be used for holding and consuming beverages. There exists a long felt need in the art for a beverage holding device that allows users to serve beverages or consume beverages without worry of spills, even while in or on a moving vehicle such as a car, boat, lawnmower, etc. There is a long felt need in art for a beverage holding device that ensures that the beverage held inside the device stays in a stable upright position to prevent spills while riding in moving vehicles. There is a long felt need in the art for a beverage holding device that allows users to easily consume beverages while performing other tasks, without worrying about spilling the beverage. Additionally, there is a long felt need in art for a beverage holding device which can be used with existing cup holders to ensure that the beverage/drink remains stable, even when the vehicle is in motion or is subjected to unpaved or poorly surfaced roads. Furthermore, there is a long felt need in the art for a beverage holding device that prevents carbonated beverages from going flat due to constant shaking and vibration from a vehicle. Finally, there is a long felt need in the art for a beverage holding device that allows users to easily handle different beverages while they are travelling in a vehicle, boat, etc., without worry of spills and getting their hands dirty.

The present invention, in one exemplary embodiment, is a novel magnetic hovering holder device for a cup. The magnetic hovering holder device comprises a cylindrical body having a connected base, wherein the circumference of the base is smaller than the circumference of the cross-sectional circular area of the cylindrical body. Further, the cross-sectional circular periphery of the cylindrical body comprises a first magnet having a first magnetic polarity, and the base comprises a second magnet of the same first magnetic polarity, thereby allowing a cup inserted into the holder to remain stable and hover due to the repelling magnetic force between the first magnet and the second magnet.

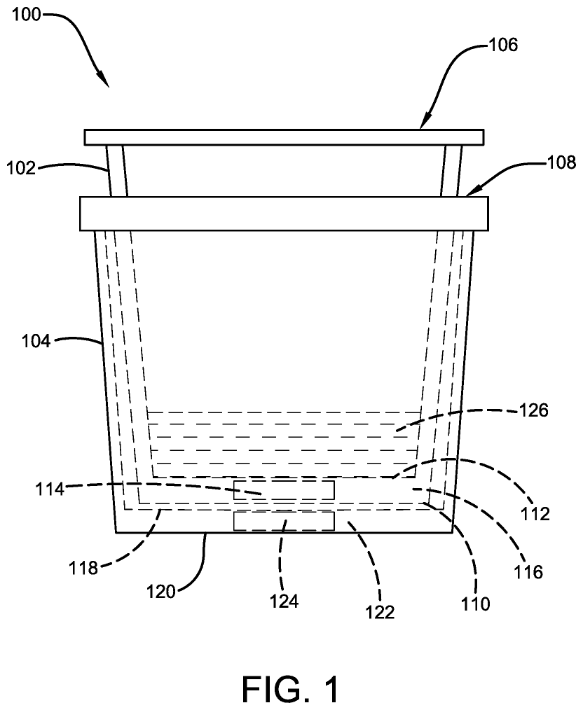

Referring initially to the drawings, FIG. 1 illustrates a perspective view of one embodiment of the magnetic holder device 100 of the present invention for holding cups and beverages. The magnetic holder device 100 is designed to be used as an insert into a cup holder, or as a standalone device for holding beverages. The magnetic holder device 100 comprises a larger, outer holder 104 and an inner holder 102. The inner holder 102 is configured to be encased within the larger, outer holder 104 through the opening 108 of the larger, outer holder 104. The inner holder 102 has an opening 106 through which a beverage can be poured into the inner holder 102.

Further, the inner holder 102 has a first outer bottom surface 110 and a first inner bottom surface 112 which form a first bottom cavity 116 within the structure of the inner holder 102. The first bottom cavity 116 comprises a built-in first magnet 114 of a first polarity. The first magnet 114 can be a nickel, nickel iron, or neodymium such as N42 or N52 magnet or any other suitable temporary magnet as is known in the art. The larger, outer holder 104 has a second outer bottom surface 120 and a second inner bottom surface 118, which form a second bottom cavity 122 within the structure of the larger, outer holder 104. The second bottom cavity 122 has a built-in second magnet 124 of the same first polarity as the first magnet 114, such that the second bottom cavity 122 has the same polarity of the first magnet 114 and the first bottom cavity 116. The same polarities of the first magnet 114 and the second magnet 124 allow a beverage 126 poured into the inner holder 102 through the opening 106 to remain stable as the inner holder 102 hovers above (e.g. because it is repelled by) the outer holder 104, thus preventing spills, even while a user holds the beverage holder device 100 in or on a moving vehicle such as an ATV (all-terrain vehicle), RV (recreational vehicle), boat, lawnmower, car, truck, etc.

It should also be noted that in use, the first outer bottom surface 110 does not contact the second inner bottom surface 118, which allows the first magnet 114 and the second magnet 124 to repel each other such that the beverage 126 within the inner holder 102 remains stable as the inner holder 102 hover over the outer holder 104. A cup (not shown) holding a beverage can also be inserted into the inner holder 102, allowing the magnetic holder device 100 to act as a cup holder. The cup, when inserted into the inner holder 102, remains stable and does not move due to the repelling forces of the first magnet 114 and the second magnet 124 which allows the inner holder 102 to hover within the outer holder 104

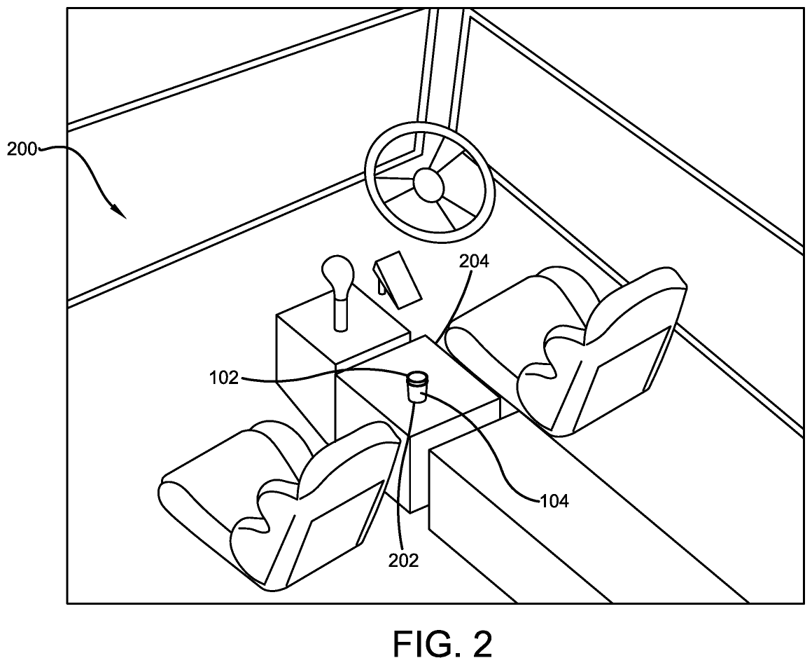

FIG. 2 illustrates a perspective view showing the magnetic holder device 100 of the present invention in use in a cupholder 202 of a vehicle. In the present embodiment, the magnetic holder device 100 comprises an inner holder 102 and a larger, outer holder 104, and is inserted into a cupholder 202. The cupholder 202 is integrated within the armrest 204 of a vehicle 200. The magnetic holder device 100 further comprises at least one magnet integrated into the bottom of the inner holder 102, and at least one magnet of the same polarity integrated into the bottom of the outer holder. As the magnets integrated into the bottom of the inner holder 102 and the larger, outer holder 104 have the same polarities, the magnetic repelling force created between the magnets allows a beverage or a cup placed within the inner holder 102 to remain upright and hover within the outer holder 104 without shaking or spilling of the contents, and without contact any surface of the holder 104.

It should be appreciated that the shape of the opening and the base of both the inner holder 102 and the larger, outer holder 104 can be round, oval, square, rectangular, etc., or any other suitable shape as is known in the art. The material of the beverage holder device 100 can be manufactured of any ferrous or non-ferrous metal or alloy, or any other suitable material as is known in the art. The magnetic holder device 100 is ideal for water and carbonated and non-carbonated drinks.

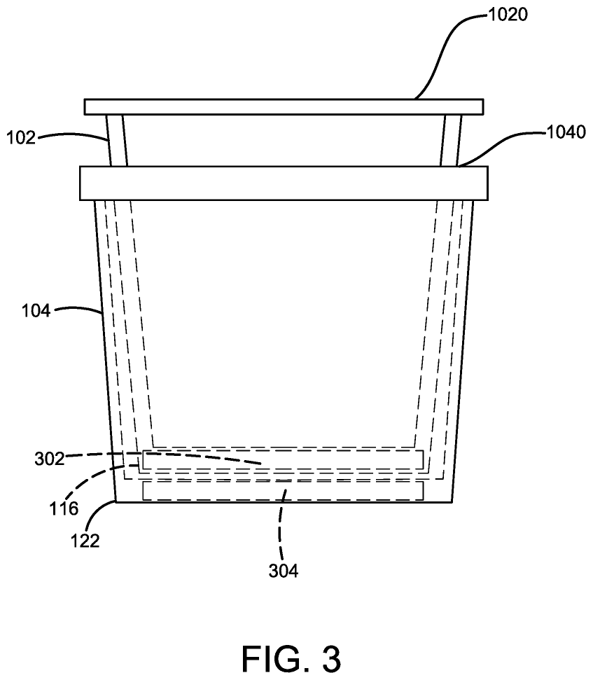

FIG. 3 illustrates a perspective view of the one embodiment of the magnetic holder device 100 of the present invention. In the present embodiment, the first bottom cavity 116 of the inner holder 102 has a first base magnet 302 of a first polarity, wherein the first base magnet 302 spans across the length of the first bottom cavity 116. Similarly, the second bottom cavity 122 of the larger, outer holder 104 has a longer second base magnet 304 of the same first polarity, wherein the second base magnet 304 spans across the length of the second bottom cavity 122. In the present embodiment, the polarity of the second base magnet 304 is the same as that of the first base magnet 302. Also, the strength of the repelling magnetic force created between the first base magnet 302 and the second magnet 304, allows the inner holder 102 to be securely retained and hover within the larger, outer holder 104. Further, the same polarities of the first base magnet 302 and the second base magnet 304 allow for the secure retention of various sizes of inner and larger, outer holders, such as an inner holder 102 and a larger, outer holder 104 of greater heights, for example heights approximately in the range of 6-9 inches. It should be noted that when in use, the first rim 1020 of the inner holder 102 can align with the second rim 1040 of the larger, outer holder 104, or alternatively can be slightly above the second rim 1040 allowing for the safe drinking of the beverage retained in the inner holder 102.

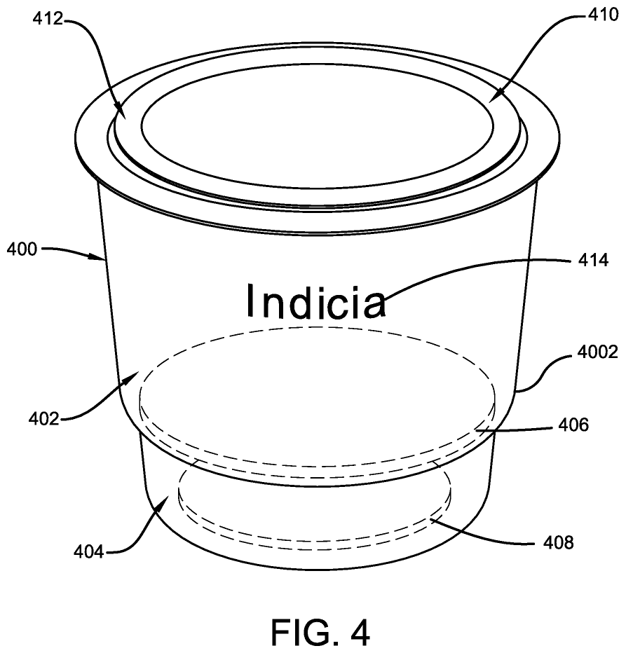

FIG. 4 illustrates a perspective view showing the magnetic holder device of the present invention for holding a cup. In the present embodiment, the magnetic holder device 400 is a single-piece component comprising a cylindrical body 402 and a circular base 404, wherein the cylindrical body 402 forms a continuous cavity 410 sized to retain a cup 412. The magnetic holder device 400 further includes a cylindrical body 402 having a connected circular base 404, wherein the circumference of the circular base 404 is smaller than the circumference of a cross-sectional circular area of the cylindrical body 402.

The magnetic holder device 400 further comprises a larger round magnet 406 positioned along the periphery of the bottom cross-sectional circular surface 4002 of the cylindrical body 402. A second smaller magnet 408, having a polarity the same as that of the larger round magnet 406, is positioned within the circular base 404. The second smaller magnet 408 is typically integrated directly within the circular base 404. Accordingly, the repelling (magnetic) force created via the interaction of the larger round magnet 406 and the second smaller magnet 408 allows a cup 412 to hover or float within the magnetic holder device 400. Thus, the cup 412 and the beverage (not shown) retained within the cup 412 remain in a stable and upright position, even while in a moving vehicle. Accordingly, the cup 412 remains stable and in a hovering (or floating) position which allows users to enjoy their favorite beverages without worry of spills or loss of carbonation due to excessive shaking of the cup 412 and the beverage retained within.

Further, the magnetic holder device 400 can carry indicia 414, for example logos, designs, or other graphics for branding and marketing purposes or any other suitable markings as are known in the art. The indicia 414 or other graphics may be positioned anywhere on the cylindrical body 402, and can be applied via etching, engraving, stickers, etc., or any other suitable means of attaching the indicia 414 as is known in the art.

Generally, the magnets of opposite polarities used in the holder devices 100, 400 of the present invention provide adequate magnetic force to allow even completely filled cups or inner holders to be supported without slippage or spills. Thus, the cup and the beverage remain erect and secure, and do not move or tilt even within moving vehicles.

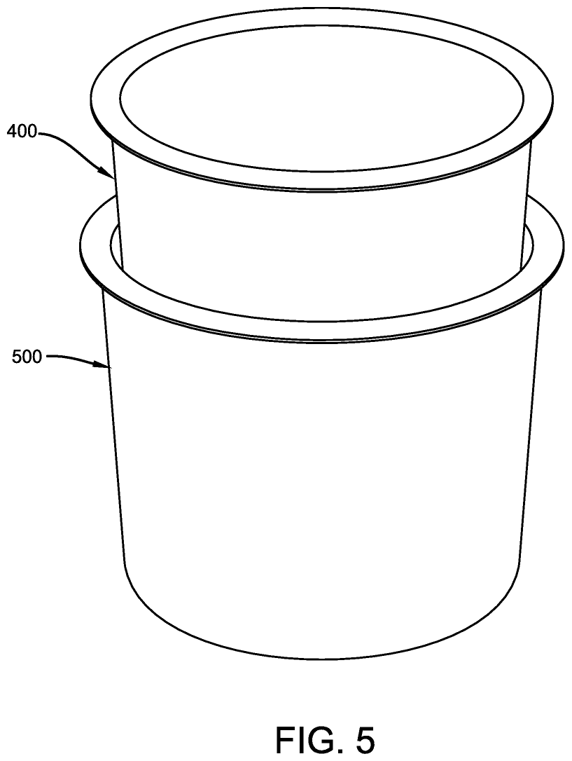

FIG. 5 illustrates a perspective view showing the magnetic holder device 400 of the present invention as a cupholder insert. The magnetic holder device 400 can be placed within a cup holder 500, thereby allowing a user to stabilize a cup or a beverage within the cup holder 500. The cup holder magnetic insert device 400 comes in a variety of sizes and shapes to fit conventional cup holders found within various vehicles, which allows users to enjoy beverages without fear of spilling. The color and shape of the magnetic holder devices 100, 400 of the present invention are based on the shape, size and material of conventional cup holders and/or beverage retainers.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “magnetic holder device”, “cup holder magnetic insert device”, “beverage holder device”, and “hovering holder device” are interchangeable and refer to the magnetic holder device 100 of the present invention.

Notwithstanding the forgoing, the magnetic holder device 100 of the present invention can be of any suitable size and configuration as is known in the art without affecting the overall concept of the invention, provided that it accomplishes the above-stated objectives. One of ordinary skill in the art will appreciate that the size, configuration and material of the magnetic holder device 100 as shown in FIGS. 1-5 are for illustrative purposes only, and that many other sizes and shapes of the magnetic holder device 100 are well within the scope of the present disclosure. Although the dimensions of the magnetic holder device 100 are important design parameters for user convenience, the magnetic holder device 100 may be of any size that ensures optimal performance during use, and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A magnetic holder device for holding a beverage, the magnetic holder device comprising:
an inner holder that is cylindrical in shape and that comprising an opening at a first end and a base at a second end that comprises a first magnet; and
an outer holder that is cylindrical in shape and that comprises an opening at a first end and a base at a second end comprising a second magnet, wherein the inner holder is sized to mate within the outer holder, such that the inner holder is retained within the outer holder, and further wherein the first magnet and the second magnet comprise a same polarity to stabilize the inner holder within the outer holder.

2. The magnetic holder device of claim 1, wherein the magnetic holder device is configured as a standalone device for holding the beverage.

3. The magnetic holder device of claim 1 wherein the magnetic holder device is configured as an insert into a cup holder.

4. The magnetic holder device of claim 1, wherein the inner holder comprises a first outer bottom surface and a first inner bottom surface which forms a first bottom cavity.

5. The magnetic holder device of claim 4, wherein the first bottom cavity comprises the first magnet.

6. The magnetic holder device of claim 5, wherein the outer holder comprises a second outer bottom surface and a second inner bottom surface which forms a second bottom cavity.

7. The magnetic holder device of claim 6, wherein the second bottom cavity comprises the second magnet.

8. The magnetic holder device of claim 7, wherein the same polarity creates a repelling magnetic force between the first magnet and the second magnet.

9. The magnetic holder device of claim 8, wherein the first outer bottom surface does not contact the second inner bottom surface such that the inner holder hovers within the outer holder.

10. The magnetic holder device of claim 1, wherein the first magnet and the second magnet comprise at least one of a nickel, a nickel iron or a neodymium.

11. The magnetic holder device of claim 10, wherein the neodymium is a N42 or a N52.

12. A magnetic holder device for holding a container, the magnetic holder device comprises:
a larger, outer holder cylindrical in shape and comprising an opening at a first end and a base at a second end comprising a second magnet which spans across a length of the base; and
an inner holder cylindrical in shape and comprising an opening at a first end and a base at a second end comprising a first magnet which spans across a length of the base, wherein the inner holder is sized to mate within the larger, outer holder, such that the inner holder is retained within the larger, outer holder, wherein the first magnet and the second magnet comprise a same polarity to stabilize the inner holder within the larger, outer holder, and further wherein a first rim of the inner holder is positioned above the second rim of the larger, outer holder.

13. The magnetic holder device of claim 12, wherein the inner holder comprises a first outer bottom surface and a first inner bottom surface which forms a first bottom cavity.

14. The magnetic holder device of claim 13, wherein the first bottom cavity comprises a built-in first magnet of a first polarity which spans a length of the first bottom cavity.

15. The magnetic holder device of claim 14, wherein the larger, outer holder comprises a second outer bottom surface and a second inner bottom surface which forms a second bottom cavity.

16. The magnetic holder device of claim 15, wherein the second bottom cavity comprises a built-in second magnet of the first polarity of the built-in first magnet which spans a length of the second bottom cavity.

17. The magnetic holder device of claim 16, wherein the first polarity repels the second polarity creating a magnetic force between the first magnet and the second magnet.

18. The magnetic holder device of claim 17, wherein a first rim of the inner holder aligns with the second rim of the larger, outer holder.

19. A magnetic holder device for holding a beverage container, the magnetic holder device comprising:
a cylindrical body comprising a bottom cross-sectional circular surface; and
a circular base, wherein the cylindrical body forms a continuous cavity sized to retain a cup, wherein a first magnet is positioned along a periphery of the bottom cross-sectional circular surface of the cylindrical body and a second magnet is positioned within the circular base, and further wherein the first magnet and the second magnet are of a same polarity which provides a magnetic force which allows a cup to hover within the cylindrical body.

20. The magnetic holder device of claim 19, wherein a circumference of the circular base is smaller than a circumference of the cross sectional circular area of the cylindrical body.
